(19) United States
(12) Patent Application Publication
(10) Pub. No.: US 2008/0281628 A1
(43) Pub. Date: Nov. 13, 2008

(54) Method And Software Product For Establishing Informed Consent

(76) Inventor: John Flynn, Queensland (AU)

Correspondence Address: JOHN ALEXANDER GALBREATH, 2516 CHESTNUT WOODS CT, REISTERSTOWN, MD, 21136, US

(21) Appl. No.: 11/570,973

(22) PCT Filed: Jun. 29, 2005
(86) PCT No.: PCT/AU2005/000947

§ 371 Date: Dec. 20, 2006

(30) Foreign Application Priority Data
Jun. 29, 2004 (AU) 2004903515

(51) Int. Cl. G06Q 50/00

(52) U.S. Cl. 705/2

(57) ABSTRACT

A method and software product by which a medical practitioner (30) is able to obtain verifiable informed consent from a patient (32) involves the use of a computer system (3) executing a software product (18). The software product contains instructions to generate a series of forms on display (6). Initial forms are used to capture identification details of patient (32). Patient biometric data, such as retinal, iris, or fingerprint scans may also be captured by means of a biometric device (29). Software product (18) further includes instructions to generate a series of question forms about a medical procedure proposed for the patient. The software product is structured so that the patient is restricted from progressing through the series of questions unless a correct answer is elicited at each stage. At the termination of the questioning phase patient (32) is prompted to reconfirm their identity details. A log of the question session is written to an optical disk (28) and an informed consent form (27) printed for signature by the patient (32). The informed consent form will preferably include an identifier uniquely identifying the optical disk (28).

### FIELD OF THE INVENTION

The present invention relates to a method and software product for establishing informed consent. The invention is particularly applicable in a situation where it is required that informed consent be obtained prior to application of medical therapy.

### BACKGROUND TO THE INVENTION

It has long been required in medical practice that a patient's written consent be obtained prior to a medical procedure being carried out. In more recent times it has been commonly held that not only must a patient consent to treatment but that this consent must be informed. A patient gives his or her informed consent when he or she consents with knowledge of the potential risks, as well as the benefits of the proposed treatment.

A significant problem, highlighted by recent escalations in litigation cases alleging negligent medical practice, is that it may be difficult to establish that a patient gave informed consent prior to a particular medical treatment. Part of this difficulty is that it has been common practice, when seeking informed consent, to provide a patient with a form detailing the potential risks associated with a particular treatment. Such a form includes a section for the patient to sign in order to indicate that they have read and understand the potential risks. However, during litigation former patient's may protest that they signed the form without comprehending the risks. For example they may state that they did not read the form put merely signed it because they trusted the doctor. Alternatively, for some procedures the forms may be quite lengthy and complex and patient's may subsequently say that they were unable to absorb the voluminous amount of information and so did not make an informed consent.

A related problem is that in some circumstances it may be difficult to establish that a particular patient that received information about a medical procedure is one and the same patient that actually signed the informed consent form.

It is an object of the present invention to provide an improved method and software product for establishing informed consent.

### SUMMARY OF THE INVENTION

According to a first aspect of the present invention there is provided a method to elicit informed consent of a patient to a medical treatment by means of a computer system; the method including the steps of:

confirming the patient's identity;

presenting the patient with a series of questions concerning the medical treatment;

processing patient answers to the questions;

subsequent to each question restricting progress through the series of questions on the basis of the patient's answers;

reconfirming the patient's identity upon successful completion of the patient's answers; and

generating a consent form upon the patient successfully reconfirming the patient's identity and answering the predetermined set of the questions correctly.

The predetermined set of the answers will typically be all of the questions concerning the medical treatment.

In a preferred embodiment of the present invention the method includes a step of recording a log of the questions and the patient's answers.

The method may include a step of capturing information identifying the patient.

Preferably the method includes a step of prompting for the patient to confirm the captured identifying information subsequent to submitting the answers.

The method may include a step of terminating the method prior to generating the consent form in the event that the patient does not confirm the captured information.

In one embodiment the invention includes capturing information identifying the patient by biometric means such as an iris or retinal or fingerprint scanner for example.

The method may include a step of saving the log to a removable data storage medium.

The method may include recording a unique identifier in respect of the removable data storage medium and printing the unique identifier upon the consent form.

In one embodiment the step of restricting progress through the series of questions on the basis of the patient's answers includes repeatedly presenting an incorrectly answered question until a correct answer is solicited.

The method may include presenting information as to why an answer to a question was deemed incorrect.

The method may include a step of converting the consent form into an electronic file and storing same within the computer system upon the consent form being signed by the patient.

Preferably the electronic file of the consent form is stored upon the removable storage medium with the log.

According to a further aspect of the present invention there is provided a computer software product for execution by an electronic processor, the computer software product bearing instructions for the electronic processor to implement the above-described method.

According to another aspect of the invention there is provided a computational device programmed to implement the previously described method.

The computational device may be connected to a computer network such as the Internet. For example, the computational device may comprise a network server.

Further preferred features of the present invention will be described in the following detailed description which will refer to a number of figures as follows.

### BRIEF DESCRIPTION OF THE DRAWINGS

FIG. 1 is a block diagram of a computer system suitable for performing a method according to an embodiment of the present invention.

FIG. 2 is a first part of a flow chart of a method according to an embodiment of the present invention.

FIG. 2A is a second part of the flow chart commenced in FIG. 2.

FIG. 3 depicts a form generated by the computer system of FIG. 1 during performance of the method of FIG. 2.

FIG. 4 depicts a further form generated by the computer system of FIG. 1 during performance of the method of FIG. 2.

FIG. 5 depicts a form generated by the computer system of FIG. 1 during performance of the method of FIG. 2.

FIG. 6 depicts a further form generated by the computer system of FIG. 1 during performance of the method of FIG. 2.

### DETAILED DESCRIPTION OF EXEMPLARY EMBODIMENTS

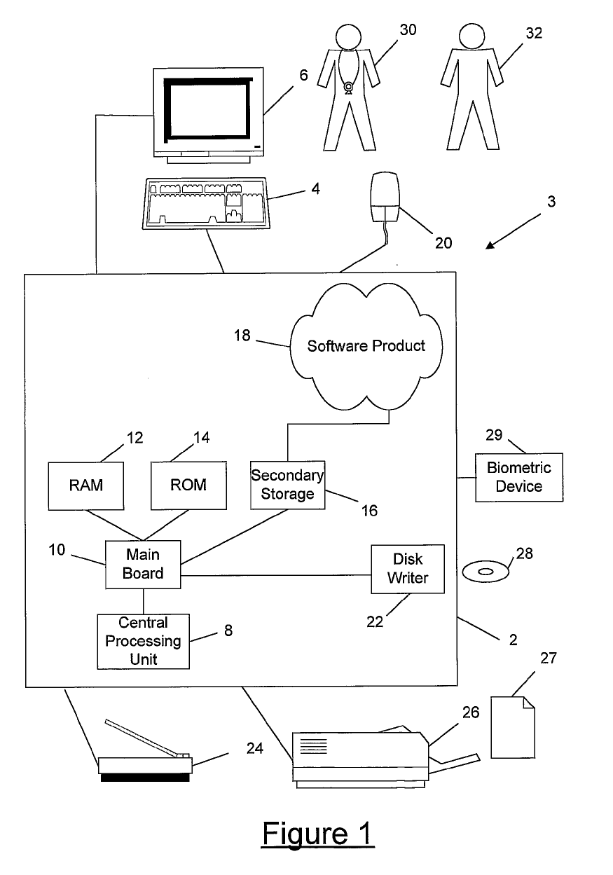

Referring now to FIG. 1, there is depicted a block diagram of a conventional computer system 3 of a type suitable for performing a method according to a preferred embodiment of the present invention.

System 3 includes a computer case 2 which houses a processor 8 (or one or more processors) that accesses RAM 12, ROM 14 and various secondary data storage devices 16 such as hard disk drives. The processor executes a software product 18 stored in data storage 16 that contains instructions for implementing a method according to the present invention. The software product is typically provided on an optical or magnetically readable medium such as a CD-ROM 28 or floppy diskette, though it might also be provided in a ROM or other electronic circuit as firmware or downloaded over a computer network such as the Internet. The software product includes instructions for system 3 to implement a method that will be explained.

By means of conventional interfacing circuitry located on a mainboard 10 within case 2, the processor receives commands from input devices such as keyboard 4 and mouse 20. Processor 8 controls and communicates with a number of peripheral devices including a scanner 24, for converting documents into electronic file format, a printer 26 for converting electronic files into paper hardcopy 26 and an optical disk writer 22 for permanently writing files to a removable optical disk 28. Processor 8 may communicate with remote computers via a network support module such as a LAN switch or Internet gateway.

Also in communication with processor 8 is a biometric scanner 29. The biometric scanner produces identification data on the basis of, for example, a retinal, iris or fingerprint scan. As will be explained, the information data may be stored with an electronic log generated during implementation of the method in order to allow for biometric authentication of the patient at a later date.

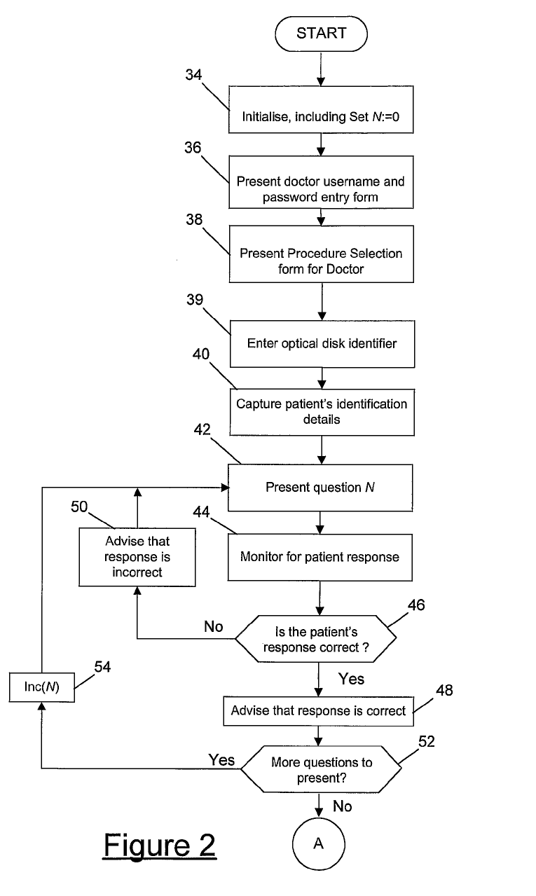

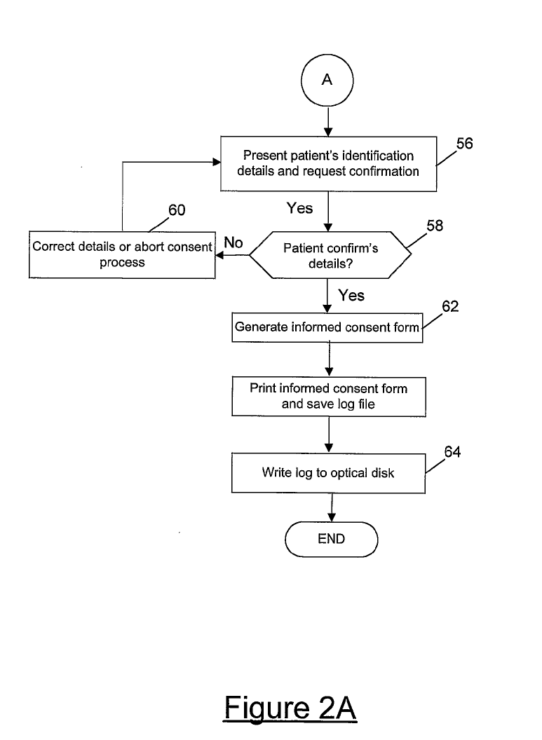

FIGS. 2 and 2A are first and second portions of a flowchart of the steps that are implemented by computer system 3 in accordance with a preferred embodiment of a method according to the present invention. Computer system 3 performs the method under control of software product 18 which contains instructions for implementing each of the various steps. It will be realised that the actual programming of software product 18 is straightforward once a method according to the present invention is known.

At box 34 computer system 3 undertakes an initialisation procedure which will typically include allocating memory and other resources to run the program. Various variables used during execution of software program 18 are initialised. For example, counter variable N is initialised to zero at box 34.

At box 36 a logon form is presented on display 6 into which doctor 30 enters a username and password. The username and password will typically have been established earlier at the time that software product 18 was loaded onto computer system 3.

At box 38 a procedure selection form is presented on screen 6. The selection form will typically present the names of a number of different medical treatments from which doctor 30 selects the treatment that it is proposed to perform upon patient 32.

At box 39 a prompt is presented asking if the operator wishes to enter the unique ID of an optical disk onto which a log of the informed consent session will be written.

At box 40 a form is presented for patient 32 to enter patient identification details. Where biometric device 29 is included in computer system 3 then it may be used at this step of the procedure to capture biometric data such as a retinal, iris or fingerprint scan of patient 32 to assist in verifying their identity.

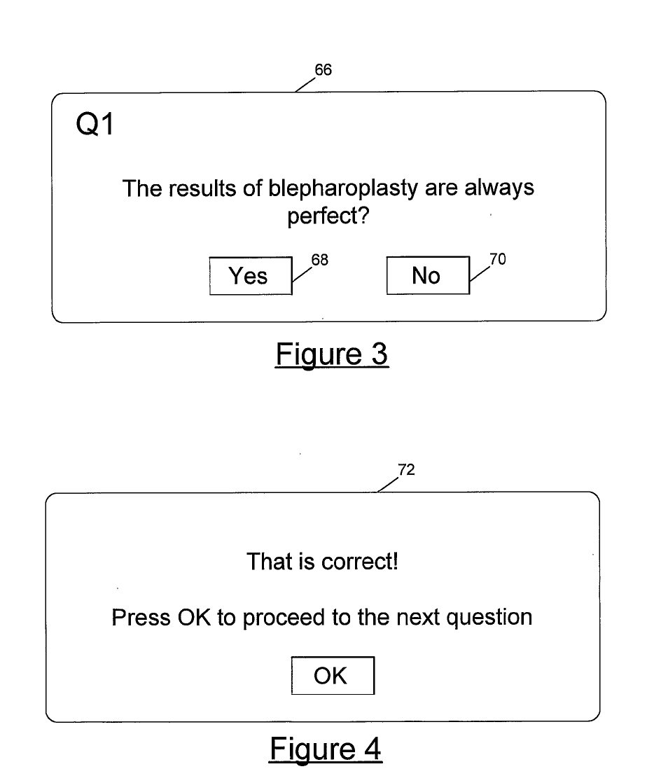

At box 42 the first of a set of questions associated with the procedure selection that was made at box 38 is presented to patient 32 on display 6. FIG. 3 shows a typical form 66 for presenting a question as it would appear on screen 6. Form 66 includes buttons 68 and 70 for patient 32 to submit a “Yes” or “No” answer to the question. Obviously a question may be presented to which there may be a range of possible answers other than “Yes” or “No”. In that case software product 18 may include instructions for presenting a form that permits for the selection between other possible answers than “Yes” or “No”.

At box 44 system 3 monitors for patient 32 to submit a response to the question that was presented at box 42. Once the patient submits a response the system determines whether the answer is correct or not at box 46. In the event that the answer is correct then control diverts to box 48. At box 48 form 72 of FIG. 4 is presented to confirm to patient 32 that the answer that was submitted is correct. Counter variable N is then incremented at box 54 and the next question is presented at box 42.

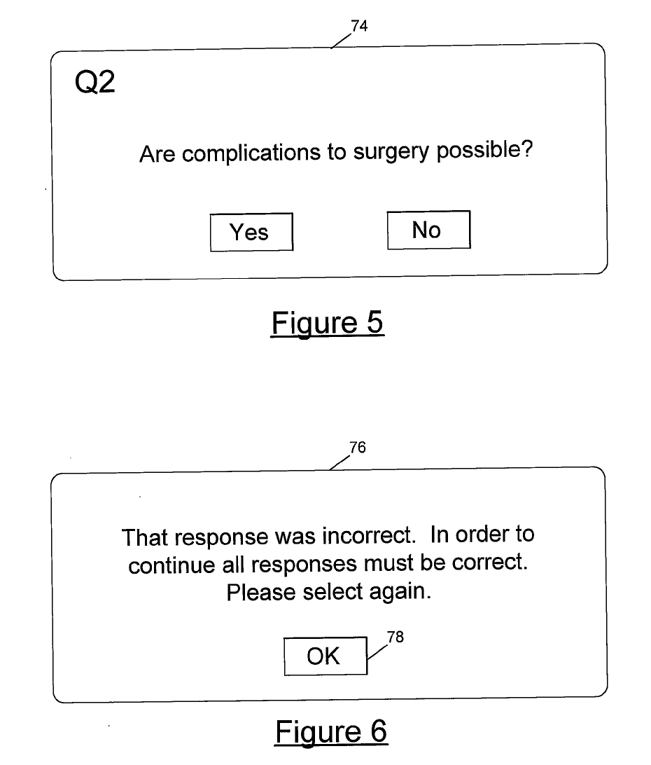

Form 74 of FIG. 5 is a specimen of a further question form that is displayed at box 42. At box 44 system 3 monitors for the patient's response to the displayed question. In the event that the response is incorrect then control diverts to box 50 and form 76 of FIG. 6 is displayed to advise patient 32 that the answer was incorrect and that they must try again. The message in form 76 may also explain why the patient's answer was incorrect. Once patient 76 has verified that they have read the message, by clicking on “OK” button 78, control diverts back to box 42 and the same message is re-presented.

Finally, once all of the questions in respect of the particular procedure have been correctly answered, box 56 is entered. At box 56 the patient's details, which were previously captured at box 40, are presented along with a request for confirmation that the details are correct. Where biometric device 29 has been incorporated then this step may include capturing a second biometric scan. Prompting for the patient to confirm their details provides a further opportunity for the patient to make a conscious decision whether or not to proceed with the informed consent process. Particularly where a biometric scan is performed, this step reduces the possibility of a person other than the patient fraudulently answering the questions presented in box 42.

At box 58 the system processes the patient's confirmation that the details are correct. If the patient does not confirm that the details are correct then at box 60 one or more forms may be generated for the patient to correct minor details that were incorrectly recorded. Alternatively, if it appears that the patient that completed the questions is not the same person as the patient that entered the details at box 40 then the process may be aborted.

Assuming that the patient confirms that the captured patient details are correct then the procedure proceeds to box 62. At box 62 system 3 produces a consent form, shown as item 26 of FIG. 1, based upon the patient and doctor details. The consent form is generated with a date and time stamp and with the doctor's and patient's identification details. The patient then signs the consent form and gives it to the doctor for storage with the patient's file. If desired the consent form may be scanned by means of scanner 24 and an electronic copy of the signed form stored in computer system 3.

A log of the doctor's and patient's identities and the questions and answers generated during the procedure may be stored on the secondary storage 16, e.g. hard disk drive, of computer system 3. Where biometric device 29 has been used then the log may contain a file of data from a biometric scan of the patient, e.g. a retinal, iris or fingerprint scan. In one embodiment of the invention the log is written to removable optical disk 28 by writer 22. As will be known, commercially available optical disks, for example CD-ROMs, each bear a unique identification number. Where the log is written to a removable optical disk, the unique identifier on disk 28 is prior-entered at box 39. Subsequently, when form 28 is generated it bears the identifier of disk 28 so that there is no question that a particular form is related to a particular disk storing the patient's log including, in some embodiments, biometric identification data.

The embodiments of the invention described herein are provided for purposes of explaining the principles thereof, and are not to be considered as limiting or restricting the invention since many modifications may be made by the exercise of skill in the art without departing from the scope of the appended claims.

1. A method to elicit informed consent of a patient to a medical treatment by means of a computer system; the method including the steps of:
capturing information identifying the patient;
confirming the patient's identity with the computer system using the captured information;
presenting the patient with a series of questions concerning the medical treatment;
processing patient answers to the questions;
subsequent to each question restricting progress through the series of questions on the basis of the patient's answers;
prompting the patient to confirm the captured identifying information upon successful completion of the patient's answers;
recapturing information identifying the patient;
reconfirming the patient's identity with the computer system using the recaptured information; and
generating a consent form upon the patient successfully reconfirming the patients identity and answering the predetermined set of the questions correctly.

2. A method according to claim 1, wherein the predetermined set of the questions comprises all of the questions concerning the medical treatment.

3. A method according to claim 1, wherein the method includes a step of recording a log of the questions and the patient's answers.

4. A method according to claim 1, including terminating the method prior to generating the consent form in the event that the patient does not confirm the captured information.

5. A method according to claim 1, wherein the steps of capturing and recapturing information identifying the patient involves using biometric means and includes operation of one or more of:
a retinal scanner;
an iris scanner;
a fingerprint scanner.

6. A method according to claim 3, including saving the log to a removable data storage medium.

7. A method according to claim 6, including recording a unique identifier in respect of the removable data storage medium and printing the unique identifier upon the consent form.

8. A method according to claim 1, wherein the step of restricting progress through the series of questions on the basis of the patient 's answers includes repeatedly presenting an incorrectly answered question until a correct answer is solicited.

9. A method according to claim 8, including presenting information as to why an answer to a question was deemed incorrect.

10. A method according to claim 3, including converting the consent form into an electronic file and storing same within the computer system upon the consent form being signed by the patient.

11. A method according to claim 10, wherein the electronic file of the consent form is stored upon the removable storage medium with the log.

12. A method according to claim 3, including capturing an identifier uniquely identifying an optical storage medium to which the log is to be written.

13. A method according to claim 12, including printing the identifier on the consent form.

14. A computer software product bearing instructions readable by a computational device to implement a method according to claim 1.

15. A computational device programmed to implement a method according to claim 1.
